(19) United States
(12) Patent Application Publication
(10) Pub. No.: US 2003/0149741 A1
(43) Pub. Date: Aug. 7, 2003

(54) Methods for implementing remote operating system procedure calls

(76) Inventor: Kevin William Krooss, Centerport, NY (US)

Correspondence Address: Kevin W. Krooss, 257 B Little Neck Road, Centerport, NY, 11721, US

(21) Appl. No.: 10/068,218

(22) Filed: Feb. 5, 2002

(51) Int. Cl. G06F 15/16

(52) U.S. Cl. 709/217; 709/203

(57) ABSTRACT

An improved (FIG. 5) communications protocol (FIG. 3, FIG. 4) and software algorithms (FIG. 1, FIG. 2) to allow a client computer to access a server computer's operating system, primitives and objects as a virtual machine.

Two code modules are required to support this technology, a server module (called the proxy) and the client module (called the stub). The software program listings are provided on two identical CD ROM copies in standard ISO-9660 format as text files, Server.txt and Client.txt.

The program listings are in hexadecimal representation. They represent the preferred embodiment, which is designed for use on the Windows operating system by Microsoft Inc. (Client) and the Tandem NSK/Guardian operating system sold by Compaq Computers Corp.

Client Component

This component should be converted from hexadecimal to binary and stored with the filename VG.OCX and properly installed into the Windows registry. It is used as a Microsoft ActiveX component object. It is not a stand-alone application but a code module, which is incorporated in a Windows application program. (ref: http://www.microsoft.com/com/tech/activex.asp)

Server Component

The Server component of the preferred embodiment should be converted to binary format from hexadecimal and stored as a file named VG on the Tandem/Guardian computer (sold by Compaq Computers Inc.) and altered to a file code of 100 (executable) file (FUP ALTER VG, CODE 100) (ref: File Utility Program (FUP) Reference Manual-425742-001) This server program file is invoked by the Tandem TCP/IP listener process upon the client program network connection. This requires making an entry in the associated PORTCONF file. See instructions available from Compaq in the Total Information Manager program (TIM) for details of installation and execution of programs on this platform. (ref: TCP/IP Operations manual)

### BACKGROUND

1. Field of Invention

A computer network may include a client and a server, which are preferably independently operable computers that cooperate to perform different procedures of an application program. The server typically executes, its procedure in response to requests from remote procedure call transmitted usually over the computer network or other communication means from the client machine. The remote procedure calls typically includes one or more data structures or parameters used as arguments for the remote procedure.

The invention relates to systems and methods of executing remote computer procedures in networked environments. In particular, improved methods for implementing remotely invoked computer procedure in arbitrary client programming languages.

2. Description of Prior Art

Note: In this document the term “packet” refers to a complete request message or a complete reply message. It should not be confused with a network communications packet such as TCP/IP packets. A request message or a reply message could consist of one or more network communications packets.

In the past, computer programs were primarily implemented on large, complex computers known as mainframes. In the past decade, there has been a trend away from such systems and towards network-based computing systems.

Network-based computing systems can implement many distributed processing techniques. One of these distributed computing environment (DCE) techniques is a client/server computing technology known as the Open Software Foundation Remote Procedure Calls (OSF/RPC, or simply RPC, ref: http://www.fi.infn.it/DFS/docs-osf.org/OSF-DCE-PD-1090-4.pdf) the disclosures of which are incorporated herein by reference. Remote procedure calls are a programming technique wherein a “client” which may, for example, be implemented in a client computer invokes a procedure as if it were local, that is, inside the client's program, when the procedure actually exists in another program implemented in another computer in the network, such as the network server. The underlying OSF/RPC support hides the complications arising from this distributed processing, allowing the programmer to code applications as if the remote server procedures were local to the client computer.

One shortcoming with current RPC technology is that it is not available in a wide variety of languages. In fact, RPC is currently defined only for use with a programming language known as “C.” This requires the programmer to have a functional capability programming in “C” even if the underlying code for the procedure is written in a completely different language, such as Perl or Visual Basic.

There is no definition in OSF/RPC for implementing a RPC interface as a Windows OCX, or any modern object oriented code module.

In OSF/RPC variables passed and returned as procedure arguments are strictly typed. If the client calls for a particular data type, a 32 bit integer for example, that is the value that must be submitted. Many modern languages support flexible data types. One example is the Variant data type provided in the Visual Basic language. If the server does not support this data type representation, it cannot be used as a RPC argument. There is little or no intelligence provided to convert data arguments from one variable type representation to another.

Another shortcoming is the considerable processing overhead required for the manipulation of the data elements contained in a RPC message. The alignments of discreet data elements on client and server computing platforms are often incompatible in terms of address alignment and endian representation (little-endian/big-endian, ref: http://www.op.net/docs/RFCs/ien-137) the disclosures of which are incorporated herein by reference. The conversion of these discreet data elements is often performed within the server computer, which places the management overhead on a shared resource. Typically, the server is the more expensive computing resource and has to expend considerable computing processing time preparing packets for processing for a multitude of client requester computers (this process is known as marshaling and demarshaling packets). Preparing these packets consumes valuable computing resources at server, which is the focal point of the client/server architecture. This represents a potential computing bottleneck, because multiple client computers require the services of a single server computer.

Another serious problem with the use of RPC is that the standardized protocol does not easily allow the translation of application programs from one computing platform to another. The server operating system calls are not supported within the dialect of RPC. For example, models of fault-tolerant computers currently sold by Compaq Computers, (previously sold by Tandem Computers Inc.), are based on a proprietary operating system, known as the Non-Stop Kernel (NSK) or the Guardian operating system. The use of these operating system calls or Application Programmer Interface (API) is required for the development of virtually any useful program targeted on the platform (NSK platform), but they are not part of the existing sub-set of any standard RPC library of procedure calls. When porting an application from the server platform to a client/server architecture it is often the case that a programmer is required to find “work around” methods to perform the equivalent server actions on the client machine. The programmer must use whatever is available from the RPC library of functions. This is time consuming and leads to the potential for creating new programming bugs in applications. In addition, there is the possibility that no alternate work-around can be found and features of the application would have to be discarded. In the case of complex applications, it may be impossible to successfully port the application to a dissimilar client platform.

Another problem with the application of RPC in software design is the inherent overhead posed by the use of a computer network. When a RPC procedure is invoked in the client information must be marshaled (staged and prepared), transmitted across a network, demarshaled (staged and prepared for the server), the call is invoked on the server, the results of the call marshaled again by the server, transmitted back to the client, and demarshaled by the client. This can consume considerable amounts of time depending on the speed of the network.

The major component of the network transmission time is frequently not for the actual data movement but network latency, transmission setup, routing and other overhead tasks. For example a typical modern network might transmit data at the speed of 10,000 bytes of data in one second, while the network bandwidth speed may be 100,000 bytes per second. The actual movement of data should occur in 1/10^{th} of a second, (100,000/10,000) but the various network overheads consume the additional 9/100^{th} seconds of the delay period.

This is analogous to saying that a letter mailed in New York destined for Los Angles “could” travel by jet airplane from New York to Los Angeles in only six hours, but due to collection, processing, sorting, handling and delivery overhead, it may actually require several days to arrive at its destination. The actual act of physical transportation is the minor part of the total chore.

Frequently in the development of computer software a repetitions of the same operating system call may be invoked, (as in the case of reading a series of records from a file). Each of the invocations of the READ procedure would suffer from the same network latency overhead described above with the associated performance penalties. There is no facility to perform an arbitrary number of operations in one RPC command invocation and return all results in one message, which would suffer the period of network overhead described above only once.

### SUMMARY OF THE INVENTION

Broadly speaking, the invention relates to improved techniques to perform Remote Procedure Calls (RPCs). These remote procedure calls may be between, for example, one or more clients and one or more servers, between two or more clients or between two or more servers. Additionally, the remote procedure calls can also be between, including but not limited to, any two devices as have heretofore been performed. Specifically:

1) Techniques that allow a broad variety of languages to be used on the client to access the server without losing beneficial features of the application language, as well as complete access to low-level features of the server platform.

2) Method of implementing RPC as an object oriented code module so that the server computer appears as a virtual machine to the client.

3) Method of converting client data types to the types required by the server and back to the types submitted by the client.

4) Methods for offloading many of the overhead chores associated with a RPC implementation onto the client machine.

5) Methods that improve performance by bundling of an arbitrary number of client requests in one RPC message packet and the results returned to the client in one message packet.

6) Techniques for accessing operating system (OS) level procedure calls from dissimilar computing OS platforms.

7) Methods for improving system performance by aligning procedure arguments so that the server performance is optimized.

In the preferred embodiment of the invention, the client module program is implemented as a Windows ActiveX control that may be bound to a wide variety Windows programming languages as a discreet Object Oriented Programming module. This allows the unique facilities of the server OS to be available on the client platform.

The preferred embodiment of the invention may be used with a server executing on the NSK operating system accessed by Windows operating system clients written in Visual Basic and C. This is not the only possible embodiment.

The invention permits access of low-level operating system calls from a different operating system platform in languages not currently available on the server computer. For example, a Visual Basic client program can access hundreds of NSK operating system calls as if they were native to the client operating system. This greatly enhances the usefulness of RPC technology as the client language features (Variant data types, the Visual Basic Integrated Development Environment, code completion, Intellisense, Source Safe, Thousands of third party OCX/ActiveX/COM controls) can be used to develop applications that interact upon and with the NSK operating system primitives and objects. Before the development of the invention, this was unavailable.

Another feature of the invention is a technique of aligning and preparing the RPC message packet arguments in the client. The Server module requires internal variables are aligned upon specific address boundaries and endian formats, dissimilar from the client architecture. The invention places the responsibility of realigning these arguments values upon the client, for both request and reply messages. This is done to place the over head processing upon the multiple client machines rather than upon the single server machine, which is typically the more expensive and performance critical system architecture component.

It is an additional feature of this invention to improve the RPC response time of various sequential tasks common to the art of computer programming by formulating compound request messages (ARRAY CALLS). The server can execute an arbitrary number of operations requested with one communique message which and accept and/or return multiple iterations of argument values. In the preferred embodiment the parameter arguments are passed between client and server with a total number of indexes equaling the number of operations iterations requested by the client and/or performed by the server.

This method drastically reduces network latency and routing delays because these penalties are only incurred once per compound transaction rather than once for each discrete transaction. As the number of requested operations per compound transaction increase, the performance benefits increase proportionally.

### OBJECTS AND ADVANTAGES

The Invention implements a protocol and methods for RPC suitable for use from a variety of programming languages, in particular Visual Basic, but also any languages that can utilize Windows OCX control modules and languages supported by the Windows operating system, such as Scripting Host, Hyper Text Markup Language (HTML), Perl, VBA and many others.

The preferred embodiment of the invention is designed for use on Compaq Computer Inc.'s fault tolerant server computers supporting the Non-Stop Kernel (NSK)/Guardian operating system and implements the procedures incorporated in the kernel (NSK/Guardian), which acts as the server component. The client component is preferably a Windows operating system ActiveX (COM) control which can access the NSK operating system calls of the server as if they were native (local) to the client computer. This is not to say that other embodiments would not be desirable. Other embodiments utilizing other client/server operating platforms would incorporate the same techniques described herein. The result is that the server operating system and facilities are accessible from the client platform as if they were native to that platform. This makes the task of porting applications from the server to the client platform much simpler and faster with fewer chances of introducing coding errors, because much of the original code and logic may remain intact. This is of great benefit when porting applications from the server to a client server model.

Part of the improvements offered by the invention is the intelligent conversion of variable types. For example, when the server requires a 16 bit integer value the client code can submit a 32 bit integer value (as long as it does not exceed the range of 2\hat{ }16), an 8 bit byte value, a Variant value, or even the ASCII string representation of the value. Any variable type that can be converted to the required value is acceptable. Those that cannot are rejected with a conversion error status.

In this embodiment, the client code component used is an ActiveX or COM based control as described by Microsoft Corp. for use on the Windows line of operating systems. As a control component, the code can be added to a number of Windows compliant programming languages as a discreet code module or even multiple iterations within an application program using the Object Oriented Programming language techniques such as inheritance, familiar to anyone versed in the art. The client module contains code stubs for useful NSK (Server) operating system procedures. When the client-side programmer invokes a stub a message is constructed and transmitted to the server. The server receives this message, invokes the NSK call, and returns any status and response values to the client. This method permits the application programmer to write code that can call the native server operating system procedures from various client-side programming languages. In fact, the preferred embodiment allows the use of any language that supports the Microsoft COM messaging standard.

One of the unique features of the invention is the design of the packet messages. They are constructed by the client to align efficiently with the memory access model of the server. In this scheme the server may act directly upon the message as it is received over the network. The discreet data elements on dissimilar computing platforms are stored in compatible formats in terms of address alignment and endian representation (little-endian/big-endian). The conversion of these discreet data elements is performed within the client computer to reduce the processing work on the server. The server typically serves many client machines and frequently becomes the performance bottleneck in client/server architectures. The invention provides a method of reducing unnecessary work performed by the server.

The invention provides a library of compound or “Array based” procedures which can request, in one transaction, an arbitrary number of sequential operating system calls to be invoked on the server machine. With this method the network latency penalty (or time delay for transmission and return transmission of data) is exacted only once for a multitude of discreet operations. For example, reading 10,000 disk file records and returning the data to the client in an appropriate storage variable. In the above example, the network latency and overhead would be reduced by a factor of 10,000 to 1, dramatically improving RPC performance and response times.

To continue the analogy of mailing a letter presented earlier, imagine a customer (Client) in New York who whished to purchase 10,000 shoes from a supplier (Server) in Los Angeles. Typical RPC protocol would require the client to submit an order for one pair of shoes, mail the request, the shoe company would process the order, and ship. The client would have to wait for each shipment of one pair of shoes to arrive before submitting the next request. To fulfill the order for all 10,000 shoes would require many years to complete. However, when implementing the protocol improvements embodied in this invention the client could request all 10,000 shoes in one order. The order would be processed by the supplier, and all 10,000 shoes would be received in one large shipment, thus reducing the time required to several days, dependent on the supplier's ability to fill orders and the air carrier's lift capability, (the processing power of the server computer and the bandwidth of the network).

### DESCRIPTION OF DRAWING FIGURES

FIG. 1 describes the communications packet structure.

FIG. 2 describes how variables are aligned by the client for efficient access by the server.

FIG. 3 is a flow chart describing the invocation of a typical operating system call. It is represented as a time sequence chart.

FIG. 4 is a flow chart describing the invocation of a compound call. It is represented as a time sequence chart.

FIG. 5 is a chart depicting the performance improvements realized by the invention.

### REFERENCE NUMERALS IN DRAWINGS

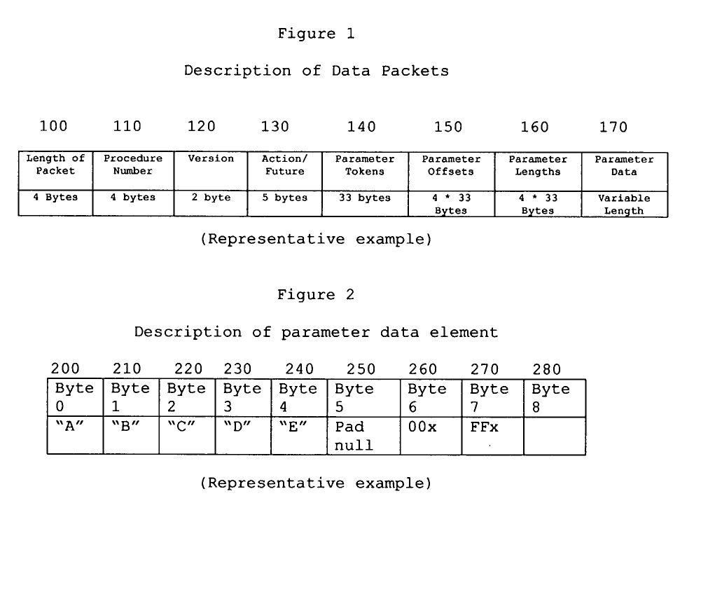

FIG. 1—This figure represents the communications packet structure. It describes eight data fields, 100-180.

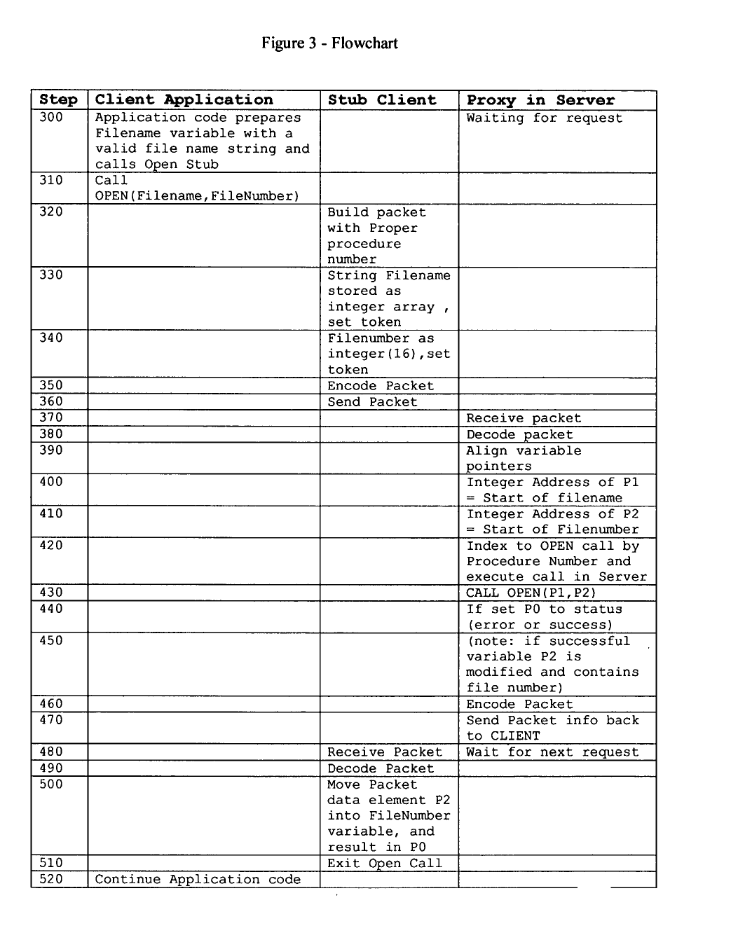

FIG. 2—Describes how argument variables are packed into the data element (FIG. 1:170) of the communications packet Nine contiguous bytes, 200-280, as depicted as an example.

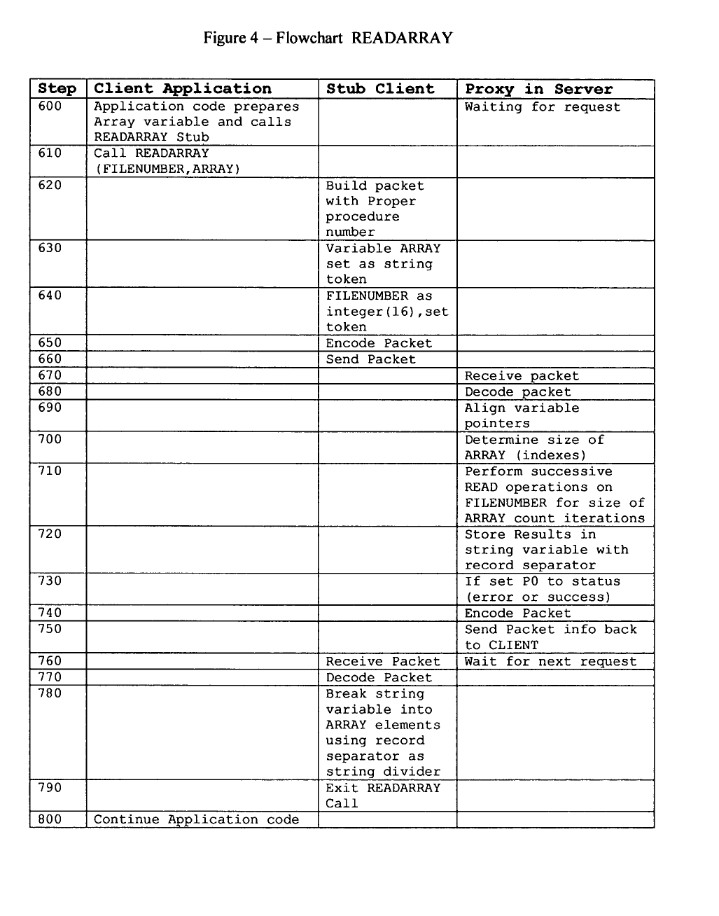

FIG. 3—This is a flow chart describing the actions of the application program (left column) the stub or client module (middle column) and the server component (right column). It is drawn in a format that permits the viewer to understand their communications interaction over a time sequence. It contains 23 periods, (300-520) and describes a typical OPEN call.

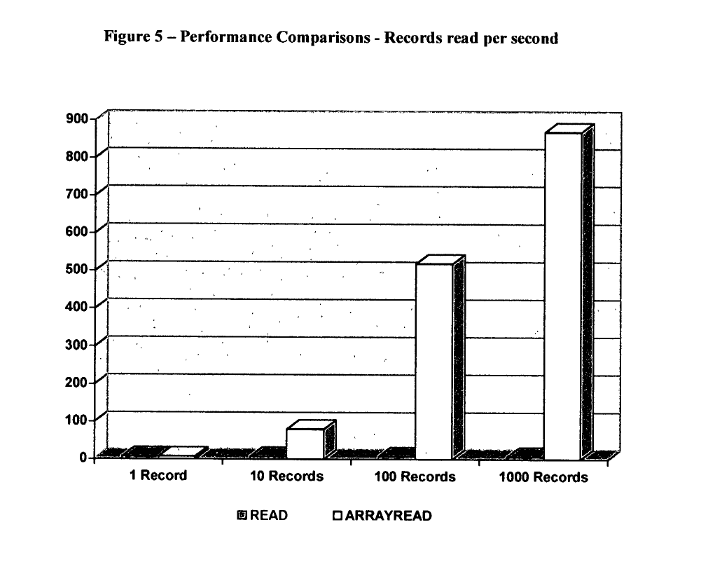

FIG. 4—This is a flow chart describing the actions of the application program (left column) the stub or client module (middle column) and the server component (right column). It is drawn in a format that permits the viewer to understand their communications interaction over a time sequence. It contains 21 periods, (600-800) and describes a compound READARRAY call.

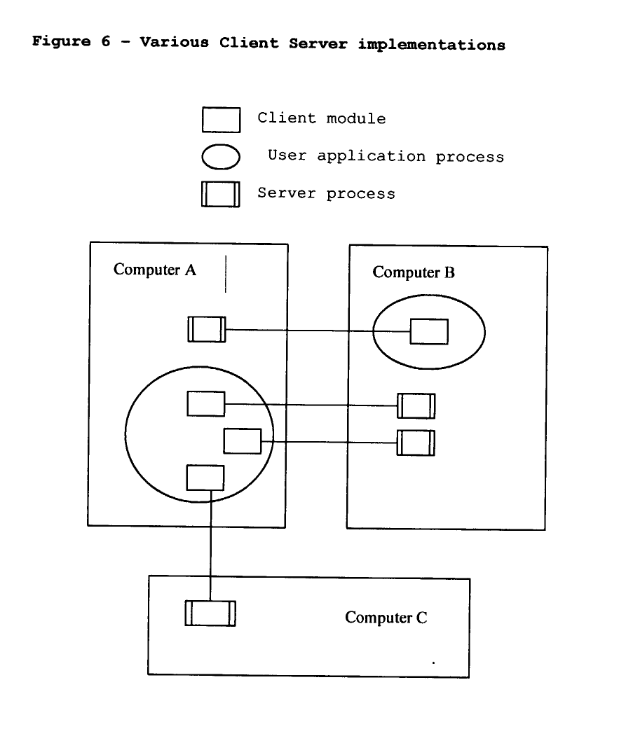

FIG. 5—A chart depicts the performance improvements provided by the compound procedure calls of the invention.

### DESCRIPTION—FIGS. 1-5 PREFERRED EMBODIMENT

FIG. 1—Packet Description

This figure describes the format of the transmission packet. The first field (100) contains the total length of the packet. The second field (110) contains the remote procedure number. The third field (120) contains the version number of the packet. The third field (130) contains the action, Request/Reply or uninitiated message, (an uninitiated message is a packet generated by the server to signify some event occurred. It is initiated spontaneously without a corresponding request from the client), flags as well as extra bytes for future use. The forth field (140) contains a series of 33 tokens or flags, which describe the data types of the parameter arguments. This includes any returned function parameter or error/status code in parameter 0. Successive tokens represent procedure call arguments (argument 1=token 1, argument 2=token 2, etc.).

The fifth field (150) contains parameter offset values. This field contains thirty-three integers values, each 32 bits in length. Each points to the start of the parameter in the data area (170) offset from the beginning of the packet. In other words, if parameter one's data starts 300 bytes from the beginning of the packet, OFFSET[1] will contain a value of 300. If parameter two's data area starts 320 bytes from the beginning of the data packet, OFFSET[2] will contain a value of 320. The sixth field (160) contains the actual length of each parameter value. The seventh field (170) contains the parameter data. Each parameter argument is packed sequentially (parameter 0, parameter 1, parameter 2, etc.) in the field. If a parameter on the host computer requires certain alignment rules enforced, the fields are aligned as required. For example, if a parameter type is defined as an Integer of 16 bits in length, the server computer of the preferred embodiment (NSK) requires such values to be aligned to start off on even address. The start of such a data value will be set to an even byte address. If the target server platform requires a different endian format than the client platform, the value is adjusted as required. These are improvements of the invention over previous art. A request packet (Client requests services from the server) will format (endian) and address align the data elements for each parameter as required by the server to reduce processing overhead in the server component. This is an improvement on the invention over prior art. An example of this feature is described in detail in FIG. 2.

FIG. 2—Description of Parameter Data Elements

This figure describes the alignment of two data parameters in the data area of the packet (see FIG. 1, 170). This example is of a request packet from the client, sent to the server.

The first 5 bytes contain a string array (200-240) containing the ASCII value “ABCDE”. The second parameter contains a Integer(16) variable with a value of 256 decimal (260-270). In the preferred embodiment of the invention a NSK server requires that integer(16) values be aligned on even address boundaries in Big-Endian notation. Normally the preceding parameter (200-240) would end on an even byte (byte 4) and the next parameter would be moved into an odd byte address. The second parameter is moved into the next even address rather than the next successive address so that the server will not have to manipulate the value. The server can directly access the variable, as it is received, intact, without further manipulation as a variable in its memory address space.

Also, in the preferred embodiment of the invention the Client architecture (Intel processor, Windows operating system) stores values in Little-Endian format (the value 256 would be stored as Hex FF00) while the server architecture (Tandem/Compaq NSK) stores values in Big-Endian format (the value 256 would be stored as hex 00FF). The invention specifies that the client code adjust the storage format of values to suit the endian format required by the server. This allows the server code to operate more efficiently as it does not have to manipulate parameter values prior to actually performing the requested remote procedure. It can act directly and immediately upon the parameters.

The role of the server is typically one where it has to support multiple clients and can become a system bottleneck. Streamlining the code in the server provides overall performance improvements. By preparation of all parameter data values in the client for the server, the server may directly access parameters transmitted without format manipulation. This greatly improves server performance as any server performance improvement also improves overall client/server architecture performance as overhead chores are shared by multiple clients.

FIG. 3—Flowchart of Typical Remote Operating System Call

Example: OPEN (Opens a file for access).

The application program prepares to place a remote operating system call, in this case OPEN a file.

It should be noted that the variable types passed to the stub code might not be of the same type required by the server. Variables are CONVERTED by the invention as necessary to facilitate simplified programming requirements. This is a benefit of the invention, which improves programmer productivity over prior art.

The application program creates a variable and fills it with a file name and declares a file number variable (300). It invokes the remote stub OPEN (310).

The stub code builds the packet and populates the passed parameters with the argument values. It also identifies the requested procedure (OPEN) with the proper procedure number or ID (320). The FILENAME parameter is stored and tagged as a INTEGER ARRAY type variable (twelve 16 bit words in length), although the variable was passed as a string type, (VARIABLE TYPE CONVERSION IS PERFORMED BY THE INVENTION), and the proper token code is set for INTEGER ARRAY, as required by the server (330). The FILENUMBER parameter is tokenized as a 16 bit integer parameter as required by the server, although it may have been passed as 32 bit integer, 16 bit integer, string text or VARIANT types, again VARIABLE TYPE CONVERSION IS PERFORMED BY THE INVENTION (340). The packet is encoded to prevent monitoring of the data (350). The packet is transmitted to the server over the network (360).

The proxy code running on the server receives the packet (370). The packet is decoded (380). Parameter pointers are set (390). The integer address of the first parameter (P1) is aligned to the data within the data element (400). The integer address of the second parameter (P2) is set to the address of that data value within the data element area (410). The procedure number of the operating system call (OPEN) is used as an index to the proxy code for the NSK operating system OPEN call (420). The OPEN call is invoked using the variable address pointers which point the proper data passed in the message buffer (430). The result of the call (Error status) is returned and placed in the P0 parameter data area (440).

If the OPEN call was successful, the FILENUMBER variable is set to the file number of the opened file in (450). The packet is encoded (460) and transmitted back to the client stub code (470) as a reply packet.

The packet is received by the client stub code (480). The packet is decoded (490) and the returned variables (P2 FILENUMBER and P0 ERROR STATUS) are set to the values passed in the packet and VARIABLE TYPE CONVERSION IS PERFORMED AS REQUIRED BY THE INVENTION (500). The program control is returned to the application level (510). The application program code continues execution (520).

FIG. 4 Flowchart of ARRAY Compound Call

This flowchart describes a typical invocation of the special enhanced technology provided by the invention. The software of the client and server provides pseudo operating system calls that permit invoking multiple iterations of operating system calls in one request/reply transaction.

This figure describes a call to READARRAY, which will read a file for a specified number of records and return all available records (up to the requested quantity or until an error or warning condition is met, such as reaching the end of the file). It is assumed that a file has previously been opened in the normal fashion and is available for reading using the file number variable named FILENUMBER.

The application program prepares an array for receiving the requested data from the procedure call (600). This is a language dependent function. In the preferred embodiment of the invention, using Visual Basic this would be performed by creating a VARIANT variable (DIM ARRAY) and dimensioning it to the desired number of records to return from the file example:

Redim ARRAY (1 to 1000) would dimension an ARRAY of 1000 elements. (ref: Visual Basic Programming manual)

A call to the STUB procedure READARRAY is performed (610) passing the file number and the array variable (FILENUMBER, ARRAY). The Stub code builds a transmission packet (620) and prepares the parameter elements (630-640). The packet is encoded (650) and transmitted to the server (660).

At this time control is passed to the server code portion of the invention. The server receives the packet (670) and decodes it (680). The variable values passed are aligned (690) and the number of array elements requested are determined (700). This count is used as the maximum number of records requested. The server enters a loop, reading records from the file opened with FILENUMBER for the number of indexes in array (710). If a file system error or warning is encountered the loop exits, otherwise processing continues.

The data received is stored sequentially in data space within the server. The records are separated by a unique record divider character sequence (720), (unique in the sense that it could not possibly appear as a sequence of characters within the data read from the file). The status of the last file READ operation performed (successful or otherwise) is stored in message packet element P0 (730). The packet is encoded (740) and transmitted back to the client code module (750). At this point the server waits for the next request (760). The client module receives the packet (760) and decodes it (770). The string variable is split into individual elements of the ARRAY (780) using the unique record separator as a divider. The array is resized if necessary (if less than the total number of records requested is returned). The status value in element P0 is used as the return status of the function and the function call exits (790). Control is returned to the application code level of the program (800).

This aspect of the invention permits large numbers of operations to be performed in one discreet transaction, greatly improving application performance. This feature of the invention is an improvement over prior art.

FIG. 5—Performance Comparisons

FIG. 5 is a graph depicting actual performance gains typically observed when ARRAY based calls are used vs. traditional discreet processing (one request per packet). The figures were based on a wide area network over the Internet. The chart describes how performance improves as the number of records requested increases. The server was a Himala K-2000 server and the client was a Pentium II running Windows 2000.

When one record is transferred there is no discernable performance improvement. An aggregate rate of seven records per second was transferred in both cases.

When ten records are requested, performance gains of ARRAY based reads are evident. The average throughput increases to a rate of eighty records per second while standard file READs still provide only seven records per second.

When one hundred records are transferred, performance gains increate with ARRAY based reads to an average throughput of 520 records per second, while standard file READs still provide only seven records per second.

When one thousand records are transferred, performance gains increate with ARRAY based reads to an average throughput of 870 records per second, while standard file READs still provide only seven records per second. This represents an improvement of over 10,000% (over one hundred times the performance of standard file READ operations).

By combining multiple operations to reduce network overhead the invention provides clear improvement over prior art.

### DESCRIPTION AND OPERATION OF ALTERNATE EMBODIMENTS

Various alternate embodiments of the invention can be realized by applying the same methods and innovations of the invention to various combinations and configurations of server and client architectures. For example, a UNIX based client could access a NSK based server or a NSK based client could access a Windows based server.

In addition, a plurality of clients with differing architectures could access the same server computer, a single client could access multiple servers of various architectures. For instance, it would be possible for a Windows based client to contain a NSK stub and a UNIX stub for accessing a NSK server and a UNIX server. Multiple stubs could be used to access a plurality of servers of differing or identical architectures. Even the same server computer can be accessed with multiple stubs to provide multiple server sessions to a client application or multiple client applications within a single plurality of client computers.

Advantages

From the description above a number of advantages of Remote Operating System Calls becomes evident.

a) By designing the client code module as a object oriented component the invention can be used by a broad variety of programming languages and technologies which may not be available to a programmer using the native server platform.

b) As an object oriented module the invention may be invoked using the advantages of a object oriented language such as polymorphism and inheritance.

c) The invention provides the ability to accept arguments in a flexible manner. The arguments need not be of the same data type as the server's procedure specifications require. Data type conversion is performed by the invention.

d) By aligning arguments in the client module to meet the requirements of the server, server overhead is reduced. Overall system performance is improved as this chore does not have to be performed by the server for all the client sessions. Each session is responsible for it's own overhead.

e) The invention enables a client to access the server at the operating system level (Application Programmer Interface), in effect creating a virtual server machine for each session within the client application.

f) The invention describes a technique for executing an arbitrary number of operating system calls in one client/server communications exchange, greatly improving performance over current RPC art.

The invention encompasses several advantages over prior art. The ability to access the operating system primitives from a remote client application provides an easy way to migrate applications from a mainframe to a workstation platform. It provides the identical operating system architecture as the ported application while offering the benefits of popular operating systems such as Windows. It allows the use of advanced user interfaces (graphics primitives, pointing devices) as well as literally tens of thousands commercially available add-in code modules to perform many useful functions (ActiveX, COM, OCX technologies) to interact with the server platform. It provides a means for common popular programming languages to access obscure server platforms. This also has an advantage of lower costs of development as development labor for more common languages typically is lower priced than platforms that require specialized skills and knowledge.

The invention provides a mechanism where the server computer can easily process requests from clients efficiently. By moving the preparation of the argument variables to the client and providing the server with a series of variables that can be directly accessed, much of the overhead is moved to multiple clients rather than the server computer handling all the overhead for all servers. The server computer by it's nature, has to process many requests from many clients, it is usually the bottleneck of a client/server architecture.

The invention provides a technique to process multiple operations in one transaction. By processing many discreet requests in one request/reply transaction the performance is greatly improved. The network latency is reduced to the point where it is inconsequential for most applications. This kind of operation (performing many sequential actions) is a very common programming requirement, for example reading or writing a number of sequential records from a file.

The invention provides the ability to use a wide variety of programming languages and software modules to access the server, many of which may not normally be available on the server platform. In the example of the preferred embodiment the Compaq/Tandem NSK Himalaya platform does not directly support Visual Basic, or Windows OCX commercial code modules. OCX or ActiveX modules are a Windows technology that allows developers to create and sell code modules that perform certain tasks which can be bound to a developer's application code module. There are literally tens of thousands of ActiveX modules available commercially or free of charge. They greatly increase the productivity of the application programmer by providing pre-developed code. These modules can be bound to the invention development environment and can be used in conjunction with the server operating system and hardware platform. This technology (OCX/ActiveX) is not available on the NSK platform.

The preferred embodiment can be used in the Visual Basic for Applications (VBA) programming environment as an ActiveX object. This allows literally hundreds of applications to be controlled via Windows Automation and interact directly with the server platform. For example the popular Windows Office suite of programs can be programmed using VBA. Menu items can be created, software routines and functions can be added to extend or modify the function of the Office Applications. The VBA language can accept the invention as an ActiveX code module, which permits the server platform to directly interact with the Office suite of applications. One embodiment of this technology might be extending Microsoft Word to open, read and write text files on the NSK server platform. This use of the invention would permit the use of the popular, familiar Microsoft WORD text editor on the server's file system as a standard text processing system. This is an example of a desirable, valuable and beneficial use of the invention, something that currently is not possible.

The invention allows a relaxed programming environment by automatically converting variables from one form to another as required. The preferred embodiment server platform (NSK) requires strongly typed variable usage. When a integer of 32 bits in length is required this is the variable type that must be used. The client module of the invention accepts variables of any type that can possibly be converted to the server's desired type. It will automatically convert them to the type required by the server prior to transmission to the server. When the server replies (sends data back to the client), the invention performs conversion back to the type used by the application programmer. For example, if the server requires a 32 bit integer value a 16 bit value, a Variant value, a single or double precision value or even a string value of ascii numbers could be passed to the stub module by the application programmer. This greatly simplifies the task of programming as the programmer may focus their attention on the business logic and algorithms, rather than language syntax rules. The invention will check values and if a conversion cannot be performed, an error is generated.

The invention can be implemented containing a subset or superset of a server's API procedures. In some implementations it may be desirable to reduce the API calls (for use in hand-held computers with limited memory) or expand the set of procedures to include user written application code.

1. A method of invoking software procedure calls within a first computer remotely from a second computer, comprising:
providing a communications channel which is able to convey information packets between said first computer and said second computer; and
providing procedure argument data elements stored in a sequence, which permit the first computer to align said data in a format and structure which enhances the second computer's processing performance by reducing the need for the second computer to manipulate said data elements.

2. The method according to claim 1 wherein said first computer is a client and said second computer is a server.

3. The method according to claim 2 wherein the client computer has the ability to align said data in a format and structure which enhances server processing performance by reducing the need for the server to manipulate said data elements.

4. The method according to claim 3 wherein the client converts the arguments of remote procedure calls from a data type submitted by an application program to a data type required by the remote server procedure definition and converting any argument responses provided by the server back to the original data type submitted by the application program in the client computer.

5. The method according to claim 4 wherein the client computer provides an ability to access the server computer at an operating system procedure level to provide a virtual server computing environment in a client computer software module.

6. The method according to claim 5 wherein the client computer compartmentalizes a virtual server as an object oriented computing module inside the client computer to provide object oriented programming features such as polymorphism and inheritance.

7. The method according to claim 6 wherein the client software component is modularized so that it can be incorporated within a broad variety of computer programming languages used in the client computer as a software object.

8. The method according to claim 2 wherein the remote procedure call is implemented as an object oriented code module so that the server computer appears as a virtual machine to the client.

9. The method according to claim 2 wherein overhead chores of the server associated with a remote programming call implementation are offloaded onto the client machine.

10. The method according to claim 2 wherein performance is improved by bundling an arbitrary number of client requests in one remote procedure call message packet and wherein any results of the request are returned to the client in one message packet.

11. The method according to claim 2 wherein the server can access operating system (OS) level procedure calls from dissimilar computing OS platforms.

12. the method according to claim 2 wherein the server supports the Non-Stop Kernel (NSK)/Guardian operating system and implements the procedures incorporated in the kernel (NSK/Guardian).

13. The method according to claim 12 wherein the client is a Windows operating system ActiveX (COM) control which can access the NSK operating system calls of the server as if they were native (local) to the client computer.

14. The method according to claim 2 wherein the packet messages are constructed by the client to align efficiently with the memory access model of the server.

15. The method according to claim 14 wherein the server acts directly upon the message as it is received over the network.

16. The method according to claim 15 wherein discreet data elements on dissimilar computing platforms are stored in compatible formats in terms of address alignment and endian representation.

17. The method according to claim 16 wherein the conversion of the discreet data elements is performed within the client computer to reduce the processing work on the server.

18. The method according to claim 17 wherein the server serves more than one client.

19. A system for invoking software procedure calls within a first computer remotely from a second computer, comprising:
a communications channel between said first computer and said second computer which is able to convey information packets between said first computer and said second computer; and
wherein procedure argument data elements are stored in a sequence, which permit the first computer to align said data in a format and structure which enhances the second computer's processing performance by reducing the need for the second computer to manipulate said data elements.

20. The method according to claim 19 wherein said first computer is a client and said second computer is a server.
